(19) United States
(12) Patent Application Publication
(10) Pub. No.: US 2010/0037664 A1
(43) Pub. Date: Feb. 18, 2010

(54) DEVICE FOR LOCKING CONTAINERS

(76) Inventor: Ekaphan Pitisethakarn, Ratchaburi (TH)

Correspondence Address: BAKER & MCKENZIE LLP;PATENT DEPARTMENT, 2001 ROSS AVENUE, SUITE 2300, DALLAS, TX, 75201, US

(21) Appl. No.: 12/200,799

(22) Filed: Aug. 28, 2008

(30) Foreign Application Priority Data
Aug. 14, 2008 (TH) 0801004232

(51) Int. Cl. E05B 67/38; B65D 55/14

(52) U.S. Cl. 70/56; 70/63

(57) ABSTRACT

The Container-Locking Device with respect to this particular invention has been designed to fasten the locking upright bar of one door of a container to another. It has been invented to include two virtually symmetrical segments of a pair of locking bar fasteners, where the flat end of each segment, opposite to the end fastened to the container door locking bar, will be fixed to one of the two virtually symmetrical segments of a padlock shroud. There is also a separation-prevention unit which prevents the shroud from being separated and eliminates the gap between the two segments when they are joined, in order to prevent a bolt cutter from being able to be inserted into the padlock shackle.

### RELATED APPLICATION

The present application claims priority under 35 U.S.C. §119(a) to Thailand Patent Application No. 0801004232, filed in the Thailand Department of Intellectual Property Office on Aug. 14, 2008, which is incorporated by reference in its entirety as if set forth in full.

### BACKGROUND

1. Technical Field

In general, this particular invention relates to anti-theft devices to protect goods stored in containers, and in particular devices for locking containers.

2. Related Art

Many different types of anti-theft devices are used extensively to help prevent goods stored inside a freight container being stolen. One of these is a regular type of lock similar to a hinge and staple set for securing house doors, comprised of a long metal plate fixed to one side of a container's doors, which can be swiveled sideways around the axis it is connected to, like a hinge. The middle section at the end of the independent plate is cut into a rectangular space, through which the U-shape bracket mounted on the other side of the container doors is inserted. The bracket is received by a padlock to secure the metal plate from being pulled off through the bracket. Another type of lock set consists of two long metal plates, each of which are fixed to the locking upright bars on both sides of the container doors. The said locking bars installed on the edges of both container doors can be swiveled sideways around the axis, and can be detached from the freight container. Each independent metal plate is bent perpendicular where the middle area at the end is cut into a hole, so that when they are swung to meet each other, the holes of both plates will be aligned, ready to be received by the padlock. However, both types of locks are unable to secure the padlock shackle from being cut.

### SUMMARY

A particular container-locking device fastens the locking upright bar of one container door to the other is described herein. In one aspect, the device includes two virtually symmetrical segments of a pair of locking bar fasteners, where the flat end of each segment is fixed to one of the two virtually symmetrical segments of a padlock shroud. The padlock shroud is also equipped with a separation-prevention unit which prevents the shroud from being separated and eliminates the gap between the two segments when they are joined, so that a bolt cutter cannot be inserted.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 illustrates the front view of the Container-Locking Device with respect to this particular invention.

FIG. 2 illustrates the back view of the Container-Locking Device, showing the padlock shroud separation-prevention unit, connected to the back side of the mechanism with respect to this particular invention.

FIG. 3 illustrates the cutaway view of the Container-Locking Device with respect to this particular invention, illustrating the structure of the padlock compartment.

### DETAILED DESCRIPTION OF THE DRAWINGS

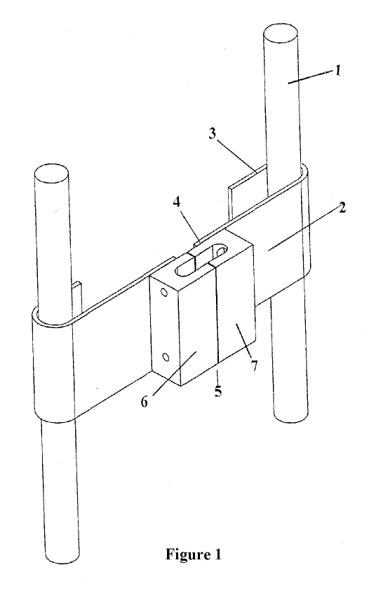

FIG. 1 illustrates the front view of the Container-Locking Device configured in accordance with the embodiments described herein. Specifically for use with freight containers with a pair of container door locking bars (1). The mechanism is comprised of a pair of hardened steel, bolt cutter-resistant locking bar fasteners (2). Each locking bar fastener (2) is made of a long, flat metal plate, where one independent end is bent into a U shape (3) to the extent that the radius of the arch corresponds with the radius of the container locking bar (1). The padlock compartment (5), with a height almost equivalent to the width of the locking bar fasteners (2), is divided into two symmetrical padlock compartment segments (6 and 7), where each segment is fixed to the front side of the flat end (4) of each locking bar fastener (2), opposite to the U-shape's independent end (3). The total length of the locking bar fasteners (2) when both sides are connected is consistent with the distance between the two container locking bars (1), installed next to each other.

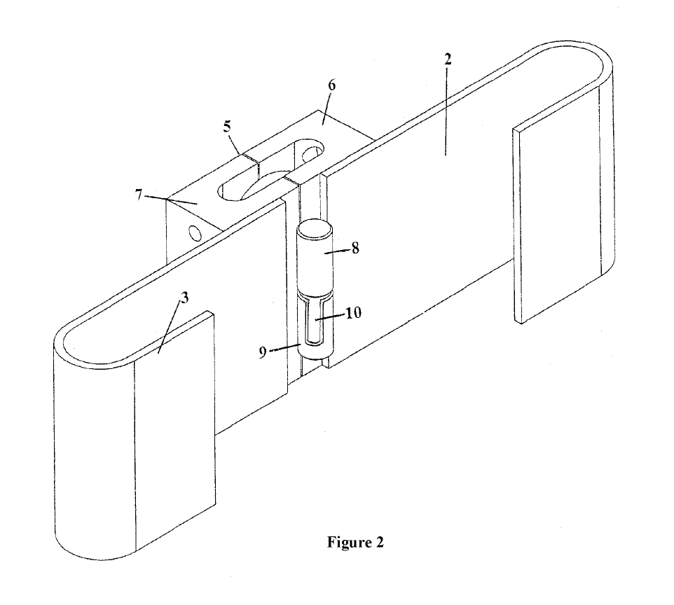

FIG. 2 illustrates the padlock shroud separation-prevention unit included on the back of the device comprising the upper section (8) and the lower section (9), both of which are similar to a cylinder and fixed to the edge of the padlock compartment segments (6 and 7), respectively. The upper cylinder-shape section (8) includes an axis pointing downwards (10) having a diameter less than that of the upper section (8). The lower section (9) is a hollow cylinder with the upper end cut open in order to support the insertion of the axis (10) of the upper section (8). However, the location of the upper section is interchangeable with that of the lower section, meaning the lower section (9) might include an axis pointing upwards, while the upper section (8) might be a hollow cylinder with the lower end cut open in order to support the insertion of the axis of the lower section.

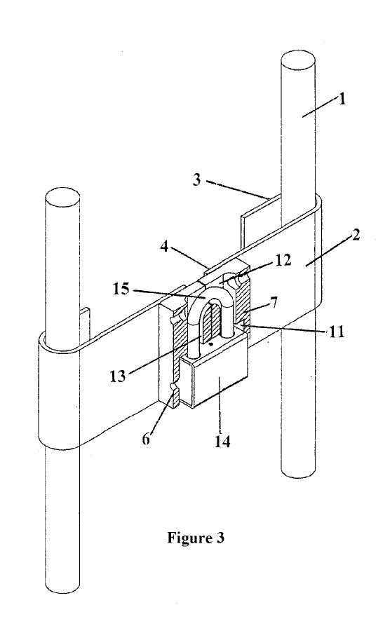

FIG. 3 illustrates a partial cutaway view of the Container-Locking Device of FIGS. 1 and 2, featuring the structure of the padlock compartment (5), with an overall square shape, divided into two symmetrical padlock compartment segments (6 and 7). A concave shaft points downwards (12) inside the upper part of each of the segments 6 and 7; likewise, there is a downward curving shaft (11) inside the lower part of the same. The concaves are made to correspond with the padlock body (14). The hollows (13) are made to create passages between the concaves 12 and the concaves 11, where the size of the hollows corresponds with the size of the padlock shackle (15), in order to support the co-entry of the shackle (15) and the padlock (14), provided that the padlock used to accompany this mechanism must be the kind which the padlock body and the shackle can be separated from each other.

While the foregoing description refers merely to one specimen embodiment of the invention, experts in this field of invention will recognize that this particular invention may be constituted by variations and modifications without departing from the original intention and scope of the invention stipulated under the Claims attached hereto.

1. The Container-Locking Device includes:
one pair of hardened steel, bolt cutter-resistant locking bar fasteners (2), each locking bar fastener (2) made of a long, flat metal plate, where one independent end is bent into a U shape (3) to the extent that a radius of the arch of the U shape corresponds with a radius of a container locking bar (1) to which each pair of the locking bar fasteners is attached; and
a padlock compartment (5), with a height almost equivalent to a width of the locking bar fasteners (2), and which is divided into two symmetrical padlock compartment segments (6 and 7), where each segment is fixed to the front side of a flat end (4) of each locking bar fastener (2), opposite to the U-shape independent end (3), wherein the total length of the locking bar fasteners (2) when both sides are connected is consistent with the distance between the two container locking bars (1), which are installed next to each other.

2. The Container-Locking Mechanism of claim 2, wherein the padlock shroud separation-prevention unit is connected to the back side of the device, between the edges of the said padlock compartment segments (6 and 7).

3. The Container-Locking Device of claim 2, wherein the said padlock shroud separation-prevention unit comprises an upper section (8) and a lower section (9), both of which are fixed to the edge of the padlock compartment segments (6 and 7), respectively, and wherein the upper section (8), which is of a cylinder shape, includes an axis pointing downwards (10), having a diameter less than that of the upper section (8), and the lower section (9) is a hollow cylinder with the upper end cut open in order to support the insertion of the axis (10) of the said upper section (8).

4. The Container-Locking Device of claim 2, wherein the said padlock shroud separation-prevention unit comprises an upper section (8) and a lower section (9), both of which are fixed to the edge of the padlock compartment segments (6 and 7), respectively, and wherein the lower section (9), which is a cylinder shape, includes an axis pointing upwards (10) and the upper section (8) is a hollow cylinder with the lower end cut open in order to support the insertion of the axis of the said lower section (9).

5. The Container-Locking Device of claim 1, further comprising a padlock body (14), and wherein the said padlock compartment (5) comprises a square shape and is divided into two symmetrical padlock compartment segments (6 and 7), each of the said segments (6 and 7) comprising a concave compartment pointing downwards (12) from the upper part of each of the said segments (6 and 7), as well as an upward pointing concave compartment (11) leading from the lower part, where both concave compartments correspond with the shape of the padlock body (14), and wherein there are two hollows (13) made to create passages between the concave compartment (12) and the concave compartment (11), where the size of the hollows corresponds with the size of the padlock shackle (15).

6. The Container-Locking Device of claim 2, further comprising a padlock body (14), and wherein the said padlock compartment (5) comprises a square shape and is divided into two symmetrical padlock compartment segments (6 and 7), each of the said segments (6 and 7) comprising a concave compartment pointing downwards (12) from the upper part of each of the said segments (6 and 7), as well as an upward pointing concave compartment (11) leading from the lower part, where both concave compartments correspond with the shape of the padlock body (14), and wherein there are two hollows (13) made to create passages between the concave compartment (12) and the concave compartment (11), where the size of the hollows corresponds with the size of the padlock shackle (15).

7. The Container-Locking Device of claim 3, further comprising a padlock body (14), and wherein the said padlock compartment (5) comprises a square shape and is divided into two symmetrical padlock compartment segments (6 and 7), each of the said segments (6 and 7) comprising a concave compartment pointing downwards (12) from the upper part of each of the said segments (6 and 7), as well as an upward pointing concave compartment (11) leading from the lower part, where both concave compartments correspond with the shape of the padlock body (14), and wherein there are two hollows (13) made to create passages between the concave compartment (12) and the concave compartment (11), where the size of the hollows corresponds with the size of the padlock shackle (15).

8. The Container-Locking Device of claim 4, further comprising a padlock body (14), and wherein the said padlock compartment (5) comprises a square shape and is divided into two symmetrical padlock compartment segments (6 and 7), each of the said segments (6 and 7) comprising a concave compartment pointing downwards (12) from the upper part of each of the said segments (6 and 7), as well as an upward pointing concave compartment (11) leading from the lower part, where both concave compartments correspond with the shape of the padlock body (14), and wherein there are two hollows (13) made to create passages between the concave compartment (12) and the concave compartment (11), where the size of the hollows corresponds with the size of the padlock shackle (15).

9. The Container-Locking Mechanisms of claim 1, wherein the said padlock compartment (5) is of a type where the shackle (15) can be separated from the padlock body (14).

10. The Container-Locking Mechanisms of claim 2, wherein the said padlock compartment (5) is of a type where the shackle (15) can be separated from the padlock body (14).

11. The Container-Locking Mechanisms of claim 3, wherein the said padlock compartment (5) is of a type where the shackle (15) can be separated from the padlock body (14).

12. The Container-Locking Mechanisms of claim 4, wherein the said padlock compartment (5) is of a type where the shackle (15) can be separated from the padlock body (14).

13. The Container-Locking Mechanisms of claim 5, wherein the said padlock compartment (5) is of a type where the shackle (15) can be separated from the padlock body (14).
